(19) United States
(12) Patent Application Publication
(10) Pub. No.: US 2012/0103218 A1
(43) Pub. Date: May 3, 2012

(54) Method of Ink Rheology Control in a Variable Data Lithography System

(75) Inventors: Timothy Stowe, Alameda, CA (US); Ashish Pattekar, San Mateo, CA (US); Dave Biegelsen, Portola Valley, CA (US); Eric Peeters, Mountain View, CA (US); James Larson, New York, CA (US)

(73) Assignee: PALO ALTO RESEARCH CENTER INCORPORATED, Palo Alto, CA (US)

(21) Appl. No.: 13/095,757

(22) Filed: Apr. 27, 2011

Related U.S. Application Data
(60) Provisional application No. 61/408,552, filed on Oct. 29, 2010.
(60) Provisional application No. 61/408,554, filed on Oct. 29, 2010.
(60) Provisional application No. 61/408,556, filed on Oct. 29, 2010.

(51) Int. Cl. B41F 1/18

(52) U.S. Cl. 101/450.1

(57) ABSTRACT

Methods for controlling the rheology of ink applied to an imaging surface of a variable data lithography system include applying ink in a layer with a first complex viscoelastic modulus such that said ink layer readily separates in regions over the imaging surface covered by a dampening solution and into regions over the imaging surface at which dampening solution has been removed, increasing the complex viscoelastic modulus of the ink to a second complex viscoelastic modulus while the ink is over the imaging surface, thereby increasing the level of at least one of ink cohesive energy and ink tack prior to the transfer of said ink to said substrate at said image transfer subsystem.

### CROSS-REFERENCE TO RELATED APPLICATIONS

The present disclosure is related to and claims priority from copending Provisional U.S. Patent Applications 61/408,552, 61/408,554, and 61/408,556, which are in their entirety incorporated herein by reference.

### BACKGROUND

The present disclosure is related to marking and printing methods and systems, and more specifically to methods and systems for variably marking or printing data using marking or printing materials such as UV lithographic and offset inks.

Offset lithography is a common method of printing today. (For the purposes hereof, the terms “printing” and “marking” are interchangeable.) In a typical lithographic process a printing plate, which may be a flat plate, the surface of a cylinder, or belt, etc., is formed to have “image regions” formed of hydrophobic and oleophilic material, and “non-image regions” formed of a hydrophilic material. The image regions are regions corresponding to the areas on the final print (i.e., the target substrate) that are occupied by a printing or marking material such as ink, whereas the non-image regions are the regions corresponding to the areas on the final print that are not occupied by said marking material. The hydrophilic regions accept and are readily wetted by a water-based fluid, commonly referred to as a fountain solution (typically consisting of water and a small amount of alcohol as well as other additives and/or surfactants to reduce surface tension). The hydrophobic regions repel fountain solution and accept ink, whereas the fountain solution formed over the hydrophilic regions forms a fluid “release layer” for rejecting ink. Therefore the hydrophilic regions of the printing plate correspond to unprinted areas, or “non-image areas”, of the final print.

The ink may be transferred directly to a substrate, such as paper, or may be applied to an intermediate surface, such as an offset (or blanket) cylinder in an offset printing system. The offset cylinder is covered with a conformable coating or sleeve with a surface that can conform to the texture of the substrate, which may have surface peak-to-valley depth somewhat greater than the surface peak-to-valley depth of the imaging plate. Also, the surface roughness of the offset blanket cylinder helps to deliver a more uniform layer of printing material to the substrate free of defects such as mottle. Sufficient pressure is used to transfer the image from the offset cylinder to the substrate. Pinching the substrate between the offset cylinder and an impression cylinder provides this pressure.

In one variation, referred to as dry or waterless lithography or driography, the plate cylinder is coated with a silicone rubber that is oleophobic and patterned to form the negative of the printed image. A printing material is applied directly to the plate cylinder, without first applying any fountain solution as in the case of the conventional or “wet” lithography process described earlier. The printing material includes ink which may or may not have some volatile solvent additives. The ink is preferentially deposited on the imaging regions to form a latent image. If solvent additives are used in the ink formulation, they preferentially diffuse towards the surface of the silicone rubber, thus forming a release layer that rejects the printing material. The low surface energy of the silicone rubber adds to the rejection of the printing material. The latent image may again be transferred to a substrate, or to an offset cylinder and thereafter to a substrate, as described above.

The above-described lithographic and offset printing techniques utilize plates which are permanently patterned, and are therefore useful only when printing a large number of copies of the same image (long print runs), such as magazines, newspapers, and the like. However, they do not permit creating and printing a new pattern from one page to the next without removing and replacing the print cylinder and/or the imaging plate (i.e., the technique cannot accommodate true high speed variable data printing wherein the image changes from impression to impression, for example, as in the case of digital printing systems). Furthermore, the cost of the permanently patterned imaging plates or cylinders is amortized over the number of copies. The cost per printed copy is therefore higher for shorter print runs of the same image than for longer print runs of the same image, as opposed to prints from digital printing systems.

Lithography and the so-called waterless process provide very high quality printing, in part due to the quality and color gamut of the inks used. Furthermore, these inks—which typically have a very high color pigment content (typically in the range of 20-70% by weight)—are very low cost compared to toners and many other types of marking materials. Thus, while there is a desire to use the lithographic and offset inks for printing in order to take advantage of the high quality and low cost, there is also a desire to print variable data from page to page. Heretofore, there have been a number of hurdles to providing variable data printing using these inks. Furthermore, there is a desire to reduce the cost per copy for shorter print runs of the same image. Ideally, the desire is to incur the same low cost per copy of a long offset or lithographic print run (e.g., more than 100,000 copies), for medium print run (e.g., on the order of 10,000 copies), and short print runs (e.g., on the order of 1,000 copies), ultimately down to a print run length of 1 copy (i.e., true variable data printing).

One problem encountered is that offset inks have too high a viscosity (often well above 50,000 cps) to be useful in nozzle-based inkjet systems. In addition, because of their tacky nature, offset inks have very high surface adhesion forces relative to electrostatic forces and are therefore almost impossible to manipulate onto or off of a surface using electrostatics. (This is in contrast to dry or liquid toner particles used in xerographic/electrographic systems, which have low surface adhesion forces due to their particle shape and the use of tailored surface chemistry and special surface additives.)

Efforts have been made to create lithographic and offset printing systems for variable data in the past. One example is disclosed in U.S. Pat. No. 3,800,699, incorporated herein by reference, in which an intense energy source such as a laser to pattern-wise evaporate a fountain solution.

In another example disclosed in U.S. Pat. No. 7,191,705, incorporated herein by reference, a hydrophilic coating is applied to an imaging belt. A laser selectively heats and evaporates or decomposes regions of the hydrophilic coating. Next a water based fountain solution is applied to these hydrophilic regions rendering them oleophobic. Ink is then applied and selectively transfers onto the plate only in the areas not covered by fountain solution, creating an inked pattern that can be transferred to a substrate. Once transferred, the belt is cleaned, a new hydrophilic coating and fountain solution are deposited, and the patterning, inking, and printing steps are repeated, for example for printing the next batch of images.

In yet another example, a rewritable surface is utilized that can switch from hydrophilic to hydrophobic states with the application of thermal, electrical, or optical energy. Examples of these surfaces include so called switchable polymers and metal oxides such as ZnO₂ and TiO₂. After changing the surface state, fountain solution selectively wets the hydrophilic areas of the programmable surface and therefore rejects the application of ink to these areas.

However, there remain a number of problems associated with these techniques. For example, most imaging plate or belt surfaces used in lithographic printing have a micro-roughened surface structure to retain fountain solution in the non-imaging areas. These hillocks and pits pocket liquid fountain solution and enhance the affinity towards the fountain solution so that this liquid does not get forced away from the surface by roller nip action. This is important because inertial shearing forces in the nip between the imaging surface and ink forming roller nip can overwhelm any static or dynamic surface energy forces drawing the fountain solution to the surface. However, these micro-roughened surfaces are difficult to clean by mechanical means such as knife-edge cleaning (effectively, scraping) systems because such knifes cannot get into the pits. In addition, physical contact between the knife and belt or drum results in significant wear of the printing surface texture. Once the surface is worn, there is a relatively high cost of replacing a belt or plate. Non-contact cleaning process such as high pressure rinsing or solvent cleaning are possible, but represent a significant cost in terms of hazardous waste disposal, a cost for additional subsystems, have unproven effectiveness, and so on.

In order to improve cleaning on each pass so as to provide ghost-free printing, prior art systems describe utilizing a very smooth belt or plate surface. See for example U.S. Pat. No. 7,191,705, referenced above. Known techniques for cleaning the surface such as scraping with a doctor blade, wiper, brushes or similar device in physical contact with the belt are more effective on a smooth surface than a rough one. But again, even with a very smooth surface, physical scraping can cause rapid surface wear.

An additional disadvantage is that a smooth surface means a reduced ability to retain the hydrophilic coating and marking material as compared to a rougher surface, and thus a smooth surface may necessitate the use of additional surface energy conditioning subsystems, such as a corona discharge apparatus, which can also induce wear and/or damage to the plate surface. In addition, precise metering of the fountain solution can become more difficult without the presence of the correct texture consisting of the hillocks and pits, as the hillocks play a role in defining the height of the solution layer as well as enabling fountain solution transfer. Furthermore, spreading and/or lateral movement of the fountain solution on a texture-free surface may be far faster after it is patterned by laser heating, thereby compromising the ultimate imaging resolution.

Another disadvantage is the relatively low transfer efficiency of the inks off of the imaging belt or drum of known systems. Common lithographic and offset processes operate with ink transfer ratios near 50:50 (i.e., about half of what is applied to the so-called “reimageable” surface actually transfers to the substrate to be printed on, the other half must ultimately be cleaned off and removed). This means that a significant amount of cleaning would need to be done to wipe the surface clean of ink to avoid ‘ghosting’ of one image onto the next one if one were to use similar processes and materials for page to page variable-data printing. Unless this ink can be recycled without contamination, the effective cost of the ink is doubled.

A related problem to cleaning from an inefficient ink transfer is that it is very difficult to recycle the highly viscous ink, and this wasted ink not only increases the effective cost of printing, but also leads to significant disposal and waste management issues—and the associated negative environmental impact. Thus, known systems have yet to provide a sufficiently high transfer ratio to reduce ink wastage and the associated clean-up/ink recycling cost.

Still another problem is how to select the proper characteristics of the ink used to provide optimized spreading on the belt or plate surface, separation into printing and non-printing areas, transfer to the substrate, and cleaning of non-printed ink. For example, current systems have not provided optimized ink rheology for ready flow of the ink on the reimageable surface to fill the voids defined by the patterned fountain solution and adhesiveness to assist in its transfer to the substrate.

In addition, one of the issues with switchable coatings, especially the switchable polymers discussed above is that they are typically prone to wear and abrasion and expensive to coat onto a surface. Another issue is that they typically do not transform between hydrophobic and hydrophilic states in the fast (e.g., submillisecond) switching timescales required to enable high speed variable data printing. Therefore, their use would be mainly limited to short-run print batches rather than to truly variable data high speed digital lithography wherein every impression can have a different image pattern, changing from one print to the next.

### SUMMARY

Accordingly, the present disclosure is directed to systems and methods for providing variable data lithographic and offset lithographic printing, which address the shortcomings identified above—as well as others as will become apparent from this disclosure. The present disclosure concerns improvements to various aspects of variable imaging lithographic marking systems based upon variable patterning of dampening solutions and methods previously discussed.

According to one aspect of the disclosure, a method and system for modifying the rheology of the printing ink is employed. The ink rheology may be modified after the ink has been applied to the aforementioned reimageable surface layer. This modification serves to provide an initial ease of flow, allowing the ink to separate easily from non-marking areas over hydrophilic regions and into marking region voids over exposed hydrophobic regions, then transition to a more viscous and tacky state to promote complete transfer from the reimageable surface layer to a substrate or offset blanket drum.

During the transfer of the ink from the ink donor roll to the reimageable surface, the viscoelastic modulus of the ink has to be sufficiently low such that the ink layer readily splits from the surface of the ink donor roll and transfers onto the reimageable surface to form a defect-free coating (ink layer) on the reimageable surface. Moreover, at the point of transfer of the ink from the reimageable surface to the substrate, the viscoelastic modulus of the ink needs to be sufficiently high such that the ink layer resists splitting and substantially all of the ink transfers from the reimageable surface to the substrate—thereby leaving a substantially clean reimageable surface that is ready for the next image formation without the need for excessive cleaning.

It is therefore understood that it may be desirable to manipulate the rheology (viscoelastic modulus) of the ink in a manner that enhances the transfer to and from the reimageable surface. This may be accomplished by a variety of subsystems in a variety of ways.

Adding a small percentage of low molecular weight monomer or using a lower viscosity oligomer in the ink formulation can, for example, obtain improved initial ink flow. Curing of a UV ink to perform a partial cross linking UV cure following application of the ink over reimageable surface layer may thereafter increase the cohesiveness and viscosity of the ink while it resides over reimageable surface layer. Alternatively, the ink may be applied onto the reimageable surface at a first, warm temperature (at which the viscoelastic modulus of the ink/marking material is sufficiently low to ensure its defect-free transfer to the reimageable surface), and then be cooled on the reimageable surface between the point of heating and the point of transfer to the substrate to achieve a temperature that is low enough to ensure a sufficiently high viscoelastic modulus to resist splitting.

Another alternative to increase the cohesion of the ink is to include a low molecular weight additive (such as a solvent) in the ink composition to escape from the ink while it is on the reimageable surface layer. In this embodiment, the rheology of the ink may be actively manipulated by adjusting the amount of solvent (e.g., organic solvents, isopar, or any other “viscosity reducer” liquids) contained within the ink, for example, through addition of an appropriate solvent prior to the ink transfer from the ink donor roll to the reimageable surface, followed by removal (e.g., through evaporation and/or absorption into a carrier gas such as air) of the desired amount of the solvent from the ink layer on the reimageable surface prior to transfer of the ink from the reimageable surface to the substrate. It is understood that the higher solvent content within the ink prior to transfer to the reimageable surface would reduce its viscoelastic modulus to the extent necessary to form a defect-free layer of the desired thickness on the image areas of the reimageable surface. Similarly, it is understood that the lower solvent content within the ink immediately prior to transfer to the substrate would increase the ink viscoelastic modulus to the extent necessary to enable the ink layer to resist splitting during the transfer from the reimageable surface to the substrate—thereby leaving a clean reimageable surface that requires minimal post-transfer cleaning, as described above.

It is understood that for the purposes of this invention, the terms “optical wavelengths” or “radiation” or “light” may refer to wavelengths of electromagnetic radiation appropriate for use in the system to accomplish patterning of the dampening solution, whether or not these electromagnetic wavelengths are normally visible to the unaided human eye, including, but not limited to, visible light, ultraviolet (UV), and infrared (IR) wavelengths, micro-wave radiation, and the like.

The above is a summary of a number of the unique aspects, features, and advantages of the present disclosure. However, this summary is not exhaustive. Thus, these and other aspects, features, and advantages of the present disclosure will become more apparent from the following detailed description and the appended drawings, when considered in light of the claims provided herein.

### BRIEF DESCRIPTION OF THE DRAWINGS

In the drawings appended hereto like reference numerals denote like elements between the various drawings. While illustrative, the drawings are not drawn to scale. In the drawings:

FIG. 1 is a side view of a system for variable lithography according to an embodiment of the present disclosure.

FIGS. 2A and 2B are cut-away side views of a reimaging portion of an imaging drum, plate or belt, without and with an intermediate layer, respectively, according to an embodiment of the present disclosure in which absorptive particulates are dispersed within a reimageable surface layer.

FIG. 3 is a cut-away side view of a reimaging portion of an imaging drum, plate or belt according to another embodiment of the present disclosure, in which a reimageable surface layer is tinted for optical absorption.

FIG. 4 is a cut-away side view of a reimaging portion of an imaging drum, plate or belt according to still another embodiment of the present disclosure, in which a reimageable surface layer it optically transparent or translucent, and is disposed over an optically absorptive layer.

FIG. 5 is a magnified cut-away side view of the reimaging portion shown in FIG. 2, having a dampening solution applied thereover and patterned by a beam B, according to an embodiment of the present disclosure.

FIG. 6 is a side view of an inker subsystem used to apply a uniform layer of ink over a patterned layer of dampening solution and portions of a reimageable surface layer exposed by the patterning of the dampening solution, according to an embodiment of the present disclosure.

FIG. 7 is a side view of a system for variable lithography according to another embodiment of the present disclosure, illustrating a flash heat lamp subsystem in place of the curing subsystem illustrated in FIG. 1.

FIG. 8 is a side view of a cleaning subsystem including a sticky, tacky roller, hard secondary roller, and doctor blade according to an embodiment of the present disclosure.

FIG. 9 is a side view of a two-stage cleaning subsystem according to an embodiment of the present disclosure.

FIG. 10 is a side view of another cleaning system with a post transfer air knife for removing remaining dampening solution and optional UV exposure system for further increasing the viscosity and tack of ink residues.

FIGS. 11A and 11B are illustrations of imaging surface texture feature spacings and feature amplitudes for the purposes of defining RSm and Ra, respectively.

FIG. 12 is a side view of an inker subsystem used to apply a uniform layer of ink having a controlled rheology through ink pre-heating over a patterned layer of dampening solution and portions of a reimageable surface layer exposed by the patterning of the dampening solution, according to an embodiment of the present disclosure.

FIG. 13 is a perspective view of an ink roller divided into individually addressable regions in a direction parallel to a longitudinal axis of the roller, according to an embodiment of the present disclosure.

FIG. 14 is a side view of an inking roller and transfer nip roller illustrating the relatively much larger diameter of the inking roller as compared to the transfer nip roller, according to an embodiment of the present disclosure.

FIG. 15 is a plot of complex viscosity versus temperature at 100 Hz oscillation frequency for three different ink formulations.

### DETAILED DESCRIPTION

We initially point out that descriptions of well known starting materials, processing techniques, components, equipment and other well known details are merely summarized or are omitted so as not to unnecessarily obscure the details of the present invention. Thus, where details are otherwise well known, we leave it to the application of the present invention to suggest or dictate choices relating to those details.

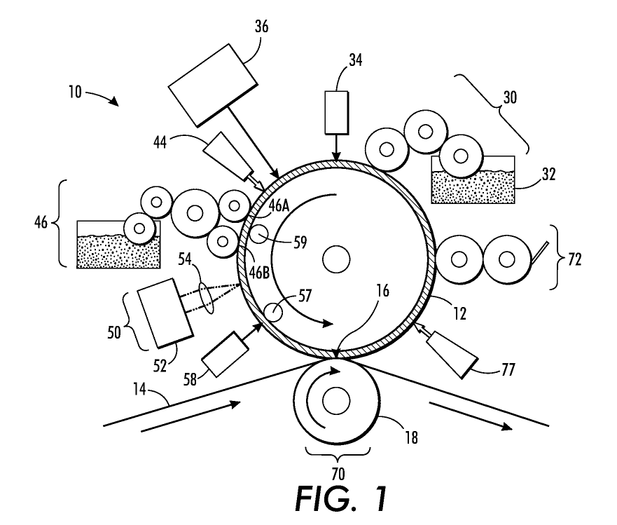

With reference to FIG. 1, there is shown therein a system 10 for variable lithography according to one embodiment of the present disclosure. System 10 comprises an imaging member 12, in this embodiment a drum, but may equivalently be a plate, belt, etc., surrounded by a number of subsystems described in detail below. Imaging member 12 applies an ink image to substrate 14 at nip 16 where substrate 14 is pinched between imaging member 12 and an impression roller 18. A wide variety of types of substrates, such as paper, plastic or composite sheet film, ceramic, glass, etc. may be employed. For clarity and brevity of this explanation we assume the substrate is paper, with the understanding that the present disclosure is not limited to that form of substrate. For example, other substrates may include cardboard, corrugated packaging materials, wood, ceramic tiles, fabrics (e.g., clothing, drapery, garments and the like), transparency or plastic film, metal foils, etc. A wide latitude of marking materials may be used including those with pigment densities greater than 10% by weight including but not limited to metallic inks or white inks useful for packaging. For clarity and brevity of this portion of the disclosure we generally use the term ink, which will be understood to include the range of marking materials such as inks, pigments, and other materials which may be applied by systems and methods disclosed herein.

The inked image from imaging member 12 may be applied to a wide variety of substrate formats, from small to large, without departing from the present disclosure. In one embodiment, imaging member 12 is at least 29 inches wide so that standard 4 sheet signature page or larger media format may be accommodated. The diameter of imaging member 12 must be large enough to accommodate various subsystems around its peripheral surface. In one embodiment, imaging member 12 has a diameter of 10 inches, although larger or smaller diameters may be appropriate depending upon the application of the present disclosure.

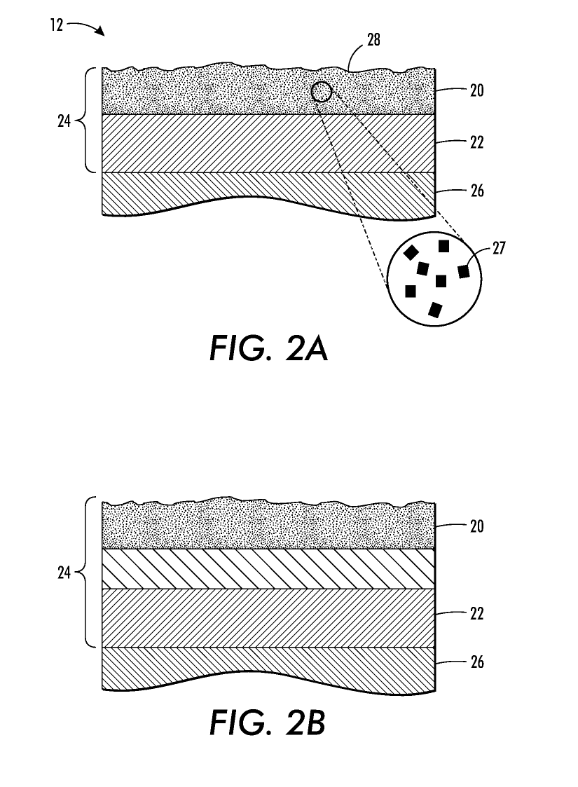

With reference to FIG. 2, a portion of imaging member 12 is shown in cross-section. In one embodiment, imaging member 12 comprises a thin reimageable surface layer 20 formed over a structural mounting layer 22 (for example metal, ceramic, plastic, etc.), which together forms a reimaging portion 24 that forms a rewriteable printing blanket. Reimaging portion 24 may further comprise additional structural layers, such as intermediate layer 21 shown in FIG. 2B, below reimageable surface layer 20 and either above or below structural mounting layer 22. Intermediate layer 21 may be electrically insulating (or conducting), thermally insulating (or conducting), have variable compressibility and durometer, and so forth. In one embodiment, intermediate layer 21 is composed of closed cell polymer foamed sheets and woven mesh layers (for example, cotton) laminated together with very thin layers of adhesive. Typically, blankets are optimized in terms of compressibility and durometer using a 3-4 ply layer system that is between 1-3 mm thick with a thin top surface layer 20 designed to have optimized roughness and surface energy properties. Reimaging portion 24 may take the form of a stand-alone drum or web, or a flat blanket wrapped around a cylinder core 26. In another embodiment the reimageable portion 24 is a continuous elastic sleeve placed over cylinder core 26. Flat plate, belt, and web arrangements (which may or may not be supported by an underlying drum configuration) are also within the scope of the present disclosure. For the purposes of the following discussion, it will be assumed that reimageable portion 24 is carried by cylinder core 26, although it will be understood that many different arrangements, as discussed above, are contemplated by the present disclosure.

Reimageable surface layer 20 consists of a polymer such as polydimethylsiloxane (PDMS, or more commonly called silicone) for example with a wear resistant filler material such as silica to help strengthen the silicone and optimize its durometer, and may contain catalyst particles that help to cure and cross link the silicone material. Alternatively, silicone moisture cure (aka tin cure) silicone as opposed to catalyst cure (aka platinum cure) silicone may be used. Returning to FIG. 2A, reimageable surface layer 20 may optionally contain a small percentage of radiation sensitive particulate material 27 dispersed therein that can absorb laser energy highly efficiently. In one embodiment, radiation sensitivity may be obtained by mixing a small percentage of carbon black, for example in the form of microscopic (e.g., of average particle size less than 10 μm) or nanoscopic particles (e.g., of average particle size less than 1000 nm) or nanotubes, into the polymer. Other radiation sensitive materials that can be disposed in the silicone include graphene, iron oxide nano particles, nickel plated nano particles, etc.

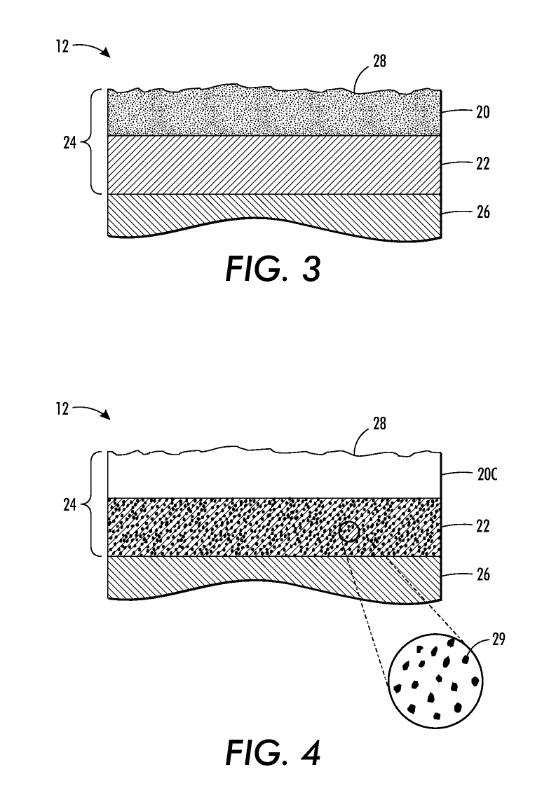

Alternatively, reimageable surface layer 20 may be tinted or otherwise treated to be uniformly radiation sensitive, as shown in FIG. 3. Still further, reimageable surface layer 20 may be essentially transparent to optical energy from a source, described further below, and the structural mounting layer or layers 22 may be absorptive of that optical energy (e.g., layer 22 comprises a component that is at least partially absorptive), as illustrated in FIG. 4.

Reimageable surface layer 20 should have a weak adhesion force to the ink at the interface yet good oleophilic wetting properties with the ink, to promote uniform (free of pinholes, beads or other defects) inking of the reimageable surface and to promote the subsequent forward transfer lift off of the ink onto the substrate. Silicone is one material having this property. Other materials providing this property may alternatively be employed, such as certain blends of polyurethanes, fluorocarbons, etc. In terms of providing adequate wetting of dampening solutions (such as water-based fountain fluid), the silicone surface need not be hydrophilic but in fact may be hydrophobic because wetting surfactants, such as silicone glycol copolymers, may be added to the dampening solution to allow the dampening solution to wet the silicone surface.

It will therefore be understood that while a water-based solution is one embodiment of a dampening solution that may be employed in the embodiments of the present disclosure, other non-aqueous dampening solutions with low surface tension, that are oleophobic, are vaporizable, decomposable, or otherwise selectively removable, etc. may be employed. One such class of fluids is the class of HydroFluoroEthers (HFE), such as the Novec brand Engineered Fluids manufactured by 3M of St. Paul, Minn. These fluids have the following beneficial properties in light of the current disclosure: (1) much lower heat of vaporization than water, which translates into lower laser power required for a given print speed, or higher print speed for a given laser power, when an optical laser is used to selectively vaporize the dampening solution to form the latent image; (2) lower heat capacity, which translates into the same benefits; (3) they leave substantially no solid residue after evaporation, which can translate into relaxed cleaning requirements and/or improved long-term stability; (4) vapor pressure and boiling point can be engineered, which can translate into an improved robustness of a spatially selective forced evaporation process; (5) they have a low surface energy, as required for proper wetting of the imaging member; and, (6) they are benign in terms of the environment and toxicity. Additional additives may be provide to control the electrical conductivity of the dampening solution. Other suitable alternatives include fluorinerts and other fluids known in the art, that have all or a majority of the above properties. It is also understood that these types of fluids may not only be used in their undiluted form, but as a constituent in an aqueous non-aqueous solution or emulsion as well.

In addition, the surface energy of silicone may be optimized to provide good wetting properties by controlling and specifying precise amounts of filler nano particles in the silicone as well as the exact chemistry of the silicone material, which can be composed of different distributions of polymer chain lengths and end group capping chemistries. For example, it has been found that single component moisture cure silicones that are tin catalyzed with low concentrations of silica filler have dispersive surface energies between 24-26 dynes/cm. Certain additives may also be added to the marking material in order to dramatically reduce the surface tension of the marking material and improve its surface wetting properties to the silicone. These additives could include, for example, leveling agents based on known copolymer fluoro or silicone chemistries that also incorporate other polymer groups for easy dispersion and curing. For example, leveling agents that can reduce ink surface tension to 21 dynes/cm.

If silicone is used as the reimageable surface layer 20, other particles 27 may also be embedded within layer 20 to help catalyze the curing and cross linking of the silicone.

According to one embodiment, reimageable surface layer 20 has roughness on the order of the desired dampening solution layer thickness to better trap the dampening solution and prevents its spreading beyond the desired non-page imaging region boundaries. For example, reimageable surface layer 20 may have measured surface roughness characteristics RSm and Ra defined as:

$$R S m = \frac{1}{m} {\sum }_{i = 1}^{m} X st$$

$$and$$

$$Ra = \frac{1}{L} {\int }_{0}^{L} \vert Z ( x ) \vert d x$$

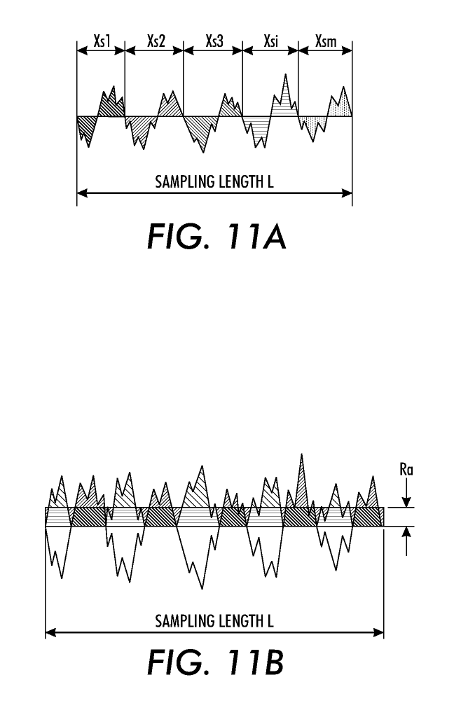

with Reference to FIGS. 11A and 11B wherein RSm is defined as the mean value of the profile element width X(s) within a sample length L and Ra is related to averaged peak to average baseline measurements over a sample length L. Thus, RSm is characteristic of the peak to peak spacing and Ra is characteristic of the peak height. Such definitions can be extended over two dimensions by using a characteristic sampling area A with dimensions A˜L².

It is desirable that the peaks and valleys are somewhat randomly distributed to reduce the possibility of Moiré interference with a linescreen pattern. In addition, it is desirable that the spatial distance between the peaks is somewhat less than the smallest line screen dot size, for example less than 10 μm. This roughness helps the surface to easily retain dampening solution while eliminating Moiré effects and acts to improve inking uniformity and transfer, as described further below. In one embodiment RSm is less than about 20 μm and the Ra is less than about 4.0 μm, and in a more specific embodiment, RSm is less than 10 μm and the Ra is between 0.1 μm and 4.0 μm.

In addition, the reimageable surface layer 20 must be wear resistant and capable of some flexibility (even under tension) in order to transfer ink off of its surface onto porous or rough paper media uniformly. The reimageable surface layer 20 may be made thick enough to achieve an appropriate elasticity and durometer and sufficient flexibility necessary for coating ink over different media types with different levels of roughness. Of course, systems may be designed for printing to a specific media type, obviating the need to accommodate a variety of media types. In one embodiment the thickness of the silicone layer forming reimageable surface layer 20 is in the range of 0.5 μm to 4 mm.

Finally, reimageable surface layer 20 must facilitate the flow of ink onto its surface with uniformity and without beading or dewetting. Various materials such as silicone can be manufactured or textured to have a range of surface energies, and such energies can be tailored with additives. Reimageable surface layer 20, while nominally having a low value of dynamic chemical adhesion, may have a sufficient surface energy in order to promote efficient ink wetting/affinity without ink dewetting or beading.

Returning to FIG. 1, disposed at a first location around imaging member 12 is dampening solution subsystem 30. Dampening solution subsystem 30 generally comprises a series of rollers (referred to as a dampening unit) for uniformly wetting the surface of reimageable surface layer 20. It is well known that many different types and configurations of dampening units exist. The purpose of the dampening unit is to deliver a layer of dampening solution 32 having a uniform and controllable thickness. In one embodiment this layer is in the range of 0.2 μm to 1.0 μm, and very uniform without pin holes. The dampening solution 32 may be composed mainly of water, optionally with small amounts of isopropyl alcohol or ethanol added to reduce its natural surface tension as well as lower the evaporation energy necessary for subsequent laser patterning. In addition, a suitable surfactant is ideally added in a small percentage by weight, which promotes a high amount of wetting to the reimageable surface layer 20. In one embodiment, this surfactant consists of silicone glycol copolymer families such as trisiloxane copolyol or dimethicone copolyol compounds which readily promote even spreading and surface tensions below 22 dynes/cm at a small percentage addition by weight. Other fluorosurfactants are also possible surface tension reducers. Optionally dampening solution 32 may contain a radiation sensitive dye to partially absorb laser energy in the process of patterning, described further below.

In addition to or in substitution for chemical methods, physical/electrical methods may be used to facilitate the wetting of dampening solution 32 over the reimageable surface layer 20. In one example, electrostatic assist operates by way of the application of a high electric field between the dampening roller and reimageable surface layer 20 to attract a uniform film of dampening solution 32 onto reimageable surface layer 20. The field can be created by applying a voltage between the dampening roller and the reimageable surface layer 20 or by depositing a transient but sufficiently persisting charge on the reimageable surface layer 20 itself. The dampening solution 32 may be electronically conductive. Therefore, in this embodiment an insulating layer (not shown) may be added to the dampening roller and/or under reimageable surface layer 20. Using electrostatic assist, it may be possible to reduce or eliminate the surfactant from the dampening solution.

Following metering of dampening solution 32 onto reimageable surface layer 20 by dampening solution subsystem 30, the thickness of the metered dampening solution is measured using a sensor 34 such as an in-situ non-contact laser gloss sensor or laser contrast sensor, such as those sold by Wenglor Sensors (Beavercreek, Ohio). Such a sensor can be used to automate the controls of dampening solution subsystem 30.

After applying a precise and uniform amount of dampening solution, in one embodiment an optical patterning subsystem 36 is used to selectively form a latent image in the dampening solution by image-wise evaporating the dampening solution layer using laser energy, for example. It should be noted here that the reimageable surface layer 20 should ideally absorb most of the energy as close to an upper surface 28 (FIG. 2) as possible, to minimize any energy wasted in heating the dampening solution and to minimize lateral spreading of the heat so as to maintain high spatial resolution capability. Alternatively, it may also be preferable to absorb most of the incident radiant (e.g., laser) energy within the dampening solution layer itself, for example, by including an appropriate radiation sensitive component within the dampening solution that is at least partially absorptive in the wavelengths of incident radiation, or alternatively by choosing a radiation source of the appropriate wavelength that is readily absorbed by the dampening solution (e.g., water has a peak absorption band near 2.94 micrometer wavelength).

It will be understood that a variety of different systems and methods for delivering energy to pattern the dampening solution over the reimageable surface may be employed with the various system components disclosed and claimed herein. However, the particular patterning system and method do not limit the present disclosure.

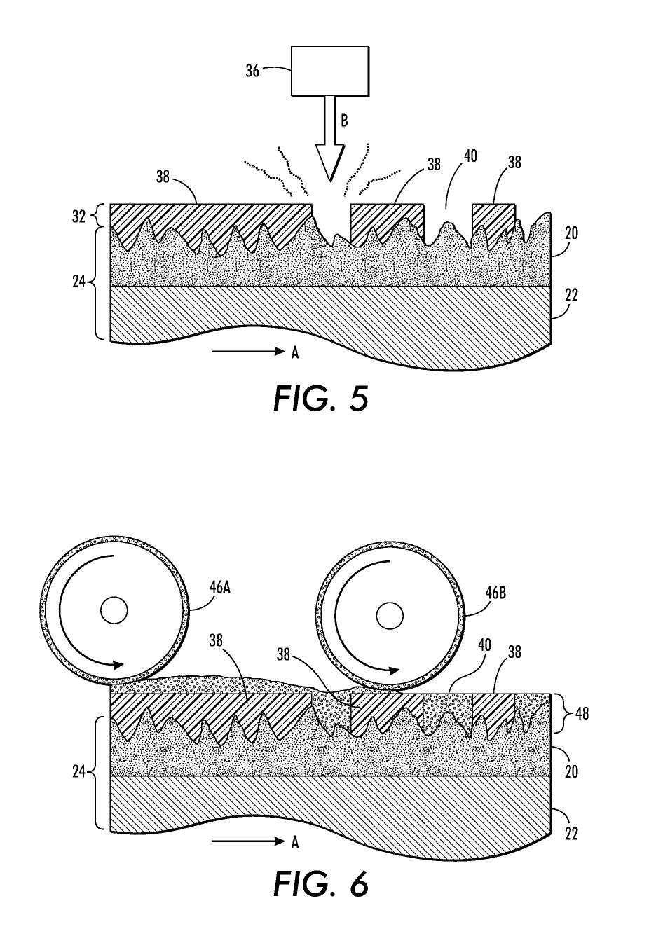

With reference to FIG. 5, which is a magnified view of a region of reimageable portion 24 having a layer of dampening solution 32 applied over reimageable surface layer 20, the application of optical patterning energy (e.g., beam B) from optical patterning subsystem 36 results in selective evaporation of portions the layer of dampening solution 32. Evaporated dampening solution becomes part of the ambient atmosphere surrounding system 10. This produces a pattern of dampening solution regions 38 and ink receiving voids 40 over reimageable surface layer 20. Relative motion between imaging member 12 and optical patterning subsystem 36, for example in the direction of arrow A, permits a process-direction patterning of the layer of dampening solution 32.

Returning to FIG. 1, following patterning of the dampening solution layer 32, an inker subsystem 46 is used to apply a uniform layer 48 of ink, shown in FIG. 6, over the layer of dampening solution 32 and reimageable surface layer 20. In addition, an air knife 44 may be optionally directed towards reimageable surface layer 20 to control airflow over the surface layer before the inking subsystem 46 for the purpose of maintaining clean dry air supply, a controlled air temperature and reducing dust contamination. Inker subsystem 46 may consist of a “keyless” system using an anilox roller to meter an offset ink onto one or more forming rollers 46a, 46b. Alternatively, inker subsystem 46 may consist of more traditional elements with a series of metering rollers that use electromechanical keys to determine the precise feed rate of the ink. The general aspects of inker subsystem 46 will depend on the application of the present disclosure, and will be well understood by one skilled in the art.

In order for ink from inker subsystem 46 to initially wet over the reimageable surface layer 20, the ink must have low enough cohesive energy to split onto the exposed portions of the reimageable surface layer 20 (ink receiving dampening solution voids 40) and also be hydrophobic enough to be rejected at dampening solution regions 38. Since the dampening solution is low viscosity and oleophobic, areas covered by dampening solution naturally reject all ink because splitting naturally occurs in the dampening solution layer which has very low dynamic cohesive energy. In areas without dampening solution, if the cohesive forces between the ink is sufficiently lower than the adhesive forces between the ink and the reimageable surface layer 20, the ink will split between these regions at the exit of the forming roller nip. The ink employed should therefore have a relatively low viscosity in order to promote better filling of voids 40 and better adhesion to reimageable surface layer 20. For example, if an otherwise known UV ink is employed, and the reimageable surface layer 20 is comprised of silicone, the viscosity and viscoelasticity of the ink will likely need to be modified slightly to lower its cohesion and thereby be able to wet the silicone. Adding a small percentage of low molecular weight monomer or using a lower viscosity oligomer in the ink formulation can accomplish this rheology modification. In addition, wetting and leveling agents may be added to the ink in order to further lower its surface tension in order to better wet the silicone surface.

In addition to this rheological consideration, it is also important that the ink composition maintain a hydrophobic character so that it is rejected by dampening solution regions 38. This can be maintained by choosing offset ink resins and solvents that are hydrophobic and have non-polar chemical groups (molecules). When dampening solution covers layer 20, the ink will then not be able to diffuse or emulsify into the dampening solution quickly and because the dampening solution is much lower viscosity than the ink, film splitting occurs entirely within the dampening solution layer, thereby rejecting ink any ink from adhering to areas on layer 20 covered with an adequate amount of dampening solution. In general, the dampening solution thickness covering layer 20 may be between 0.1 μm-4.0 μm, and in one embodiment 0.2 μm-2.0 μm depending upon the exact nature of the surface texture.

The thickness of the ink coated on roller 46a and optional roller 46b can be controlled by adjusting the feed rate of the ink through the roller system using distribution rollers, adjusting the pressure between feed rollers and the final form rollers 46a, 46b (optional), and by using ink keys to adjust the flow off of an ink tray (show as part of 46). Ideally, the thickness of the ink presented to the form rollers 46a, 46b should be at least twice the final thickness desired to transfer to the reimageable layer 20 as film splitting occurs. It is also possible to use a keyless system which can control the overall ink film thickness by using an anilox roller with uniformly formed ink carrying pits and maintaining the temperature to achieve the desired ink viscosity. Typically, the final film thickness may be approximately 1-2 μm.

Ideally, an optimized ink system 46 splits onto the reimageable surface at a ratio of approximately 50:50 (i.e., 50% remains on the ink forming rollers and 50% is transferred to the reimageable surface at each pass). However, other splitting ratios may be acceptable as long as the splitting ratio is well controlled. For example, for 70:30 splitting, the ink layer over reimageable surface layer 20 is 30% of its nominal thickness when it is present on the outer surface of the forming rollers. It is well known that reducing an ink layer thickness reduces its ability to further split. This reduction in thickness helps the ink to come off from the reimageable surface very cleanly with residual background ink left behind. However, the cohesive strength or internal tack of the ink also plays an important role.

There are two competing results desired at this point. First, the ink must flow easily into voids 40 so as to be placed properly for subsequent image formation. Furthermore, the ink should flow easily over and off of dampening solution regions 38. However, it is desirable that the ink stick together in the process of separating from dampening solution regions 38, and ultimately it is also desirable that the ink adhere to the substrate and to itself as it is transferred out of voids 40 onto the substrate both to fully transfer the ink (fully emptying voids 40) and to limit bleeding of ink at the substrate. These competing results may be obtained by modifying the cohesiveness and viscosity components of the complex viscoelastic modulus of the ink while it resides over reimageable surface layer 20.

There are several methods for increasing the cohesiveness and viscosity of the ink while it resides over reimageable surface layer 20. The first is to use an optically curable (photocurable) ink, one for example that cures with a wavelength in the range of 200-450 nanometers (nm), and a rheology (complex viscoelastic modulus) control subsystem 50 to perform a partial cross linking cure following application of the ink over reimageable surface layer 20. The partial cure increases the ink's cohesive strength relative to its adhesive strength to reimageable surface layer 20. In one embodiment utilizing ultraviolet (UV) offset ink, this partial curing comprises exposure of the ink to the output of a UV led array 52. UV led array 52 may typically have a wavelength in the range of 360-450 nm. This long UV (“near-UV”) wavelength may allow the partial cure to penetrate the thickness of the ink layer without causing excessive surface cure or surface skinning (which can result in inadequate adhesion of the ink to the final substrate surface). Introducing a proper balance of different photoinitiators to the ink formulation can reduce surface skinning and increase depth of cure. In addition, the photoinitiators may be designed to initiate curing at higher wavelengths, for example as high as 470 nm. To further improve the curing, UV led array 52 may be focused on the substrate, rather than using a diffuse source. This reduces the shallow angle surface absorption and reflection of light energy as well as increases light peak intensity useful for overcoming oxygen inhibition issues which sometimes reduce the effectiveness of photoinitiators. This can be accomplished using optics 54 such as high numerical aperture (NA) miniature microlenses as part of the UV led curing subsystem, such as available from SolidUV Inc. (www.soliduv.com) or by using a single high NA condenser lens. Flowing inert gases (not shown) such as CO₂, argon, nitrogen, etc. can also reduce oxygen inhibition for higher speed applications.

In another embodiment, heating may partially cure the ink. The ink may or may not be photocurable, such as by exposure to ultraviolet (UV) or non-UV wavelengths. For non-UV offset inks cured by heat, a focused infrared (IR) lamp may be used to increase ink cohesion, optionally with wavelength appropriate photoinitiators introduced into the ink similar to that discussed above. Other curing methods include drying, chemical curing initiated through the application of energy other than ultraviolet and IR radiation, multi-component chemical curing, etc.

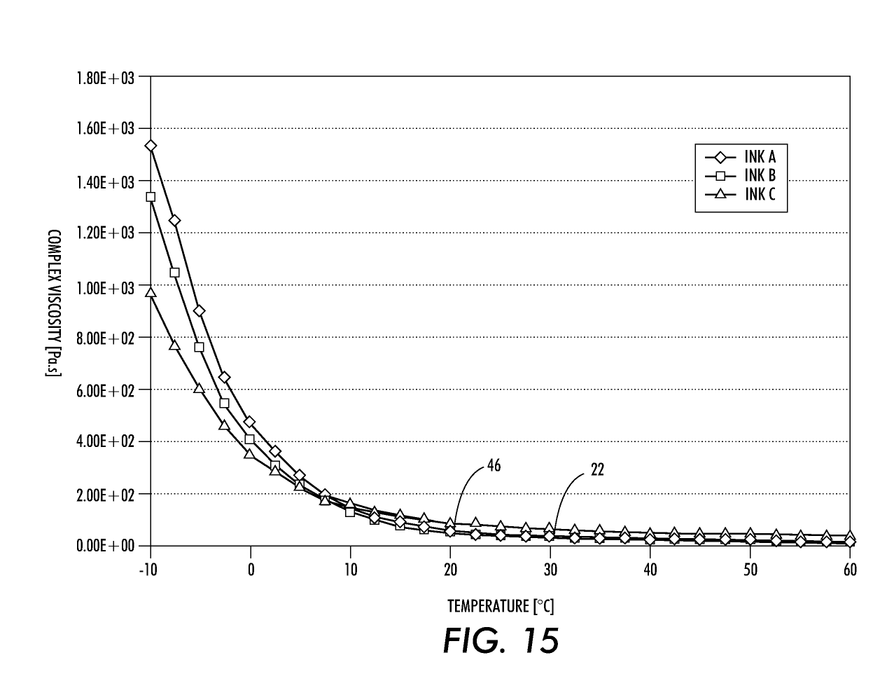

According to still another embodiment, a system and method for increasing the cohesion and viscosity of the ink employs cooling of the ink, in situ on the surface of reimageable surface layer 20, following application of said ink thereover. In a warm state, high molecular weight resins tend to flow past each other much more easily. This results in a reduction in viscosity of the offset ink with increasing temperature. Applied relatively warm, the ink may flow and separate as desired to coat the image areas of the reimageable surface. However, when the ink is cooled on reimageable surface layer 20 its viscosity can be raised. FIG. 15 is a plot of complex viscosity versus temperature at 100 Hz oscillation frequency for three different ink formulations. It will be noted that in each case, cooling increases viscosity and cohesion to aid in transfer to substrate 14. For example, cooling the ink from 30 C to 20 C increases effectively doubles the viscosity of the ink, greatly increasing its cohesion to substrate 14. The rise in the ink's internal cohesion promotes efficient transfer off of reimageable surface layer 20. According to one embodiment, this method of cohesive change is implemented by introducing a cooling agent to a surface of said imaging member opposite said imaging surface, such as water-cooling of an inside surface of the central drum through a duct such as 59 or by blowing cool air over the reimageable surface from jet 58 after the ink has been applied but before the ink is transferred to the final substrate. Other cooling alternatives include: cooling gas sources spaced apart from and directed towards said imaging surface, cooling gas sources disposed within said imaging member, electrical cooling sources spaced apart from and directed towards said imaging surface, electrical cooling sources disposed within imaging member, cooling fluid sources disposed within said imaging member, and chemical cooling sources disposed within said imaging member, and maintaining the air surrounding reimageable surface layer 20 at a lower temperature. Electrical cooling sources as referenced here may, for example, be in the form of Peltier cooling elements that act as heat removal devices upon the application of an electrical current. It is also contemplated that a portion of imaging member 12 closest to inker subsystem 46 is maintained at a first temperature by heating element 59 and a portion of imaging member 12 closer to nip 16 is maintained at a cooler second temperature by cooling element 57, facilitating even distribution of ink over the latent image formed in the dampening solution and simultaneously effective transfer of the ink to substrate 14 at nip 16.

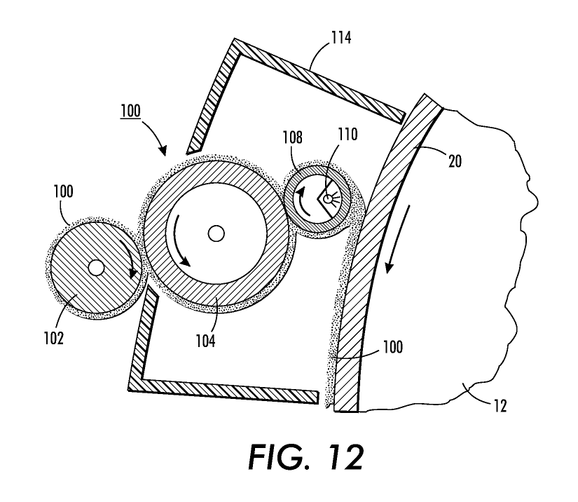

Similarly, in certain embodiments it may be advantageous to heat the ink on the forming rollers prior to applying the ink onto reimageable surface layer 20. This approach is described in further detail below and with regard to FIG. 12.

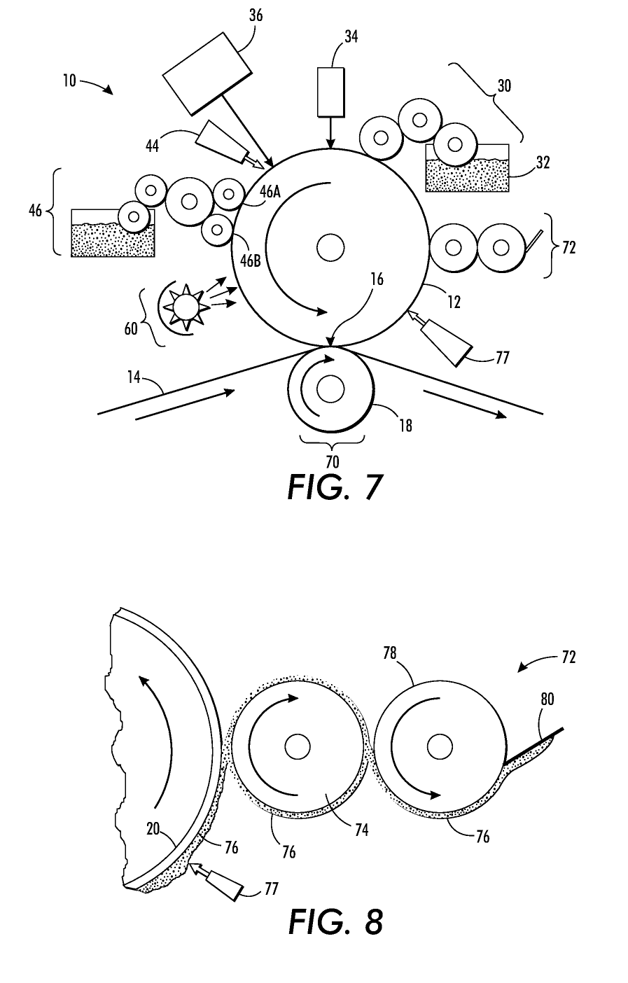

A third method for increasing the cohesion of the ink is to induce a low molecular weight additive (such as a solvent) in the ink composition to escape from the ink while it is on reimageable surface layer 20. This can be realized by a partial flash cure of the ink that rapidly raises the ink temperature, inducing evaporation of the additive. A flash heat lamp subsystem 60, shown in FIG. 7 may be used to flash cure the ink. Desorption of the additive from the ink layer can also be accomplished by using an additive that is preferentially absorbed onto or into reimageable surface layer 20. For example, certain silicone based low molecular weight compounds (typically liquids at room temperature) would readily be absorbed into the silicone layer leaving the ink formulation in a high viscosity state. This second approach may have the added benefit that the additive may act to create a weak fluid boundary “release” layer at the ink-to-silicone interface, i.e., a splitting layer that acts to promote the liftoff of the ink from the surface.

A further embodiment for partially curing ink while it is on reimageable surface layer 20 includes chemical curing that may be initiated (induced) through the application of energy other than UV radiation, including for example, thermal, other wavelength radiation, etc., Single or multi-component chemical curing are contemplated. In the case of multi-component chemical curing, one or more additional components may be added when curing needs to be initiated, with the first one or more components being already mixed with or applied under or over the ink.

The ink is next transferred to substrate 14 at transfer subsystem 70. In the embodiment illustrated in FIG. 1, this is accomplished by passing substrate 14 through nip 16 between imaging member 12 and impression roller 18. Adequate pressure is applied between imaging member 12 and impression roller 18 such that the ink within voids 40 (FIG. 6) is brought into physical contact with substrate 14. Adhesion of the ink to substrate 14 and strong internal cohesion cause the ink to separate from reimageable surface layer 20 and adhere to substrate 14. Impression roller or other elements of nip 16 may be cooled to further enhance the transfer of the inked latent image to substrate 14. Indeed, substrate 14 itself may be maintained at a relatively colder temperature than the ink on imaging member 12, or locally cooled, to assist in the ink transfer process. The ink can be transferred off of reimageable surface layer 20 with greater than 95% efficiency as measured by mass, and can exceed 99% efficiency with system optimization.

Some dampening solutions may also wet substrate 14 and separate from reimageable surface layer 20, however, the volume of this dampening solution will be minimal, and it will rapidly evaporate or be absorbed within the substrate.

Alternatively, it is within the scope of this disclosure that an offset roller (not shown) may first receive the ink image pattern, and thereafter transfer the ink image pattern to a substrate, as will be well understood to those familiar with offset printing. Other modes of indirect transferring of the ink pattern from imaging member 12 to substrate 14 are also contemplated by this disclosure.

Following transfer of the majority of the ink to substrate 14, any residual ink and residual dampening solution must be removed from reimageable surface layer 20, preferably without scraping or wearing that surface. Most of the dampening solution can be easily removed quickly by using an air knife 77 with sufficient air flow. However some amount of ink residue may still remain. According to one embodiment disclosed herein, removal of this remaining ink is accomplished at cleaning subsystem 72 shown in FIG. 1, and in more detail in FIG. 8, by using a first cleaning member, such as sticky, tacky member 74, in physical contact with reimageable surface layer 20. While shown and described as a roller, tacky member 74 may be a plate, belt, etc. Tacky member 74 has a high surface adhesion and pulls the residual ink 76 and any remaining (small) amounts of surfactant compounds from the dampening solution off reimageable surface layer 20.

In one embodiment, the tacky roller is covered with a sticky polyurethane material, highly viscous pine rosin or similar tacky rosin ester (commonly referred to pine tar), or rosin-like material, which has high adhesive strength and low surface roughness. Pine tar is a sticky material produced by the high temperature carbonization of pine wood in anoxic conditions (dry distillation or destructive distillation), consisting primarily of aromatic hydrocarbons, tar acids, and tar bases. (See, e.g., http://en.wikipedia.org/wiki/Pine_tar). Other types of wood tar may also be effectively used for the purposes described. In general, wood tar is a viscous liquid with chief constituents of volatile terpene oils, neutral oils of high boiling point and high solvency, resin, and fatty acids (see, e.g., http://www.maritime.org/conf/conf-kaye-tar.htm). Since the highly viscous inks that are typically used in lithographic printing are themselves sticky or tacky, as ink residues accumulate on the surface of tacky member 74 the ink layer itself promotes stiction of ink residue to itself on the surface of tacky member 74. This build up will continue until the layer of residual ink becomes too thick and ink film splitting begins.

To appropriately manage the residual ink at this point, tacky member 74 can simply be removed and replaced. Alternatively, tacky member 74 can be brought into contact with a second cleaning member 78, having a relatively hard, smooth surface and high surface energy, such as a ceramic, hard steel, chrome, etc. roller, plate, belt and so forth, which continuously splits off part of the accumulated ink residual layer. Once an initial layer of ink (which can be seeded or alternatively built up as a consequence of contact with tacky member 74) accumulates on second cleaning member 78, the tackiness of the ink itself causes ink from tacky member 74 to accumulate over second cleaning member 78, and thereby be removed from tacky member 74. Second cleaning member 78 can be removed and replaced, or cleaned with a doctor blade 80, in contact therewith, such as one made of high strength steel traditionally used for gravure printing and the like, which may be removable and replaceable. Given that the surface of second cleaning member 78 is relatively much harder and smoother than the surface of tacky member 74, contact between the surface of second cleaning member 78 and doctor blade 80 during cleaning of second cleaning member 78 results in less wear and performance erosion as compared to direct doctor blade cleaning of the surface of tacky member 74.

The buildup of removed ink, and worn components can be addressed by replacement of the specific elements. For example, the system can be configured such that the cleaning consumable can be readily replaceable rollers, or a low cost doctor blade 80.

In an exemplary embodiment, the Ra of surface layer 20 is less than or equal to approximately one-half the thickness of an ink layer formed thereover. (Tacky member 74 may have a surface roughness Ra₁ and surface layer 20 a second surface roughness Ra₂, such that Ra₁≦Ra₂.) Therefore, if an ink residue remains after transfer to substrate 14, it should protrude from surface layer 20. The durometer (a commonly used technical measure of hardness, stiffness, and deformability) of the silicone is sufficiently low that any ink residue trapped in a valley on surface layer 20 will at least partially contact tacky member 74 due to deformation of the surface of member 74, permitting member 74 to thereby remove that residue. In this exemplary embodiment, tacky member 74 is of an intermediate durometer between that of surface layer 20 and second member 78, so that the surface layer 20 will deform more than the tacky member 74. In addition, to avoid the chance of ink drop outs, the Ra of tack member 74 in this embodiment may be chosen to be no higher than that of surface layer 20.

Alternatively, as ink accumulates over tacky member 74, the ink layer itself is sufficiently tacky that it can support several layers of ink removed from reimageable surface layer 20. Thus, in order to remove one roller and all scraping from the cleaning process, and thereby simplify cleaning subsystem 72, it is possible simply to rely on tacky member 74 to remove all residual ink from reimageable surface layer 20. In such a system, periodic changing of such tacky member 74 is all that would be required to maintain printing performance from reimageable surface layer 20.

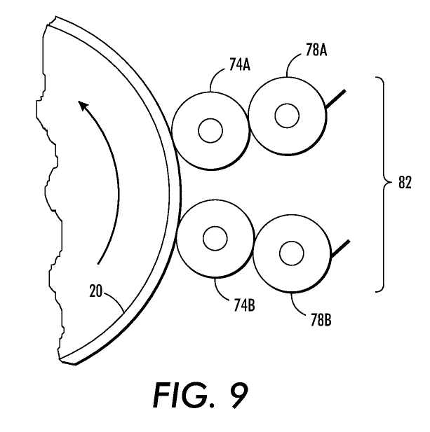

In certain embodiments, a single-stage cleaning subsystem will be sufficient to remove nearly 100% of the residual ink, leaving reimageable surface layer 20 clean and ready for a new application of dampening solution 32, patterning, inking, and transfer. However, in other embodiments, it may be desirable or necessary to provide a two-stage cleaning subsystem 82, such as illustrated in FIG. 9, including a first pair of tacky member 74a and hard secondary member 78a, and a second pair of tacky member 74b and hard secondary member 78b. Operation of each stage is essentially as described above, with the second stage further removing material not effectively removed by the first. In one embodiment relative surface roughnesses are controlled such that tacky member 74a has a surface roughness Ra₁, tacky member 74b has a surface roughness Raₛ, and imaging surface a surface roughness Ra₃, such that Ra₂≦Ra₁≦Ra₃. The hard secondary members 78a, 78b may have lower surface roughness than the tacky members 74a, 74b. It should be recognized that added stages of cleaning could be used. It should be further noted that regardless of the various cleaning systems and approaches described herein, the subject matter disclosed herein still inherently provides for a significantly lower clean-up requirement due to the unique nature of the reimageable member surface and it's interaction with the marking materials used, which provide a substantial or near-complete transfer of the marking material layer to the substrate at the image transfer step, as described in this disclosure.

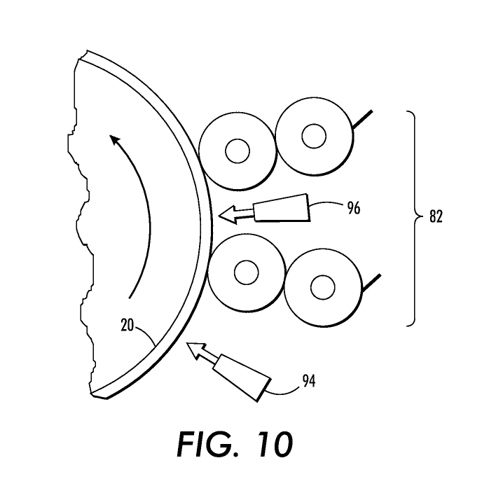

According to another embodiment of this disclosure, the ink may be modified at this point, prior to reaching the cleaning roller(s), to assist with removal of residual ink (and dampening solution residue). Different approaches may be used here. For example, residual ink may be further cured so that it is brittle, more cohesive, or “dry” and more easily removed. Curing may be provided by a post-print curing subsystem 94, illustrated in FIG. 10. If a UV-curable ink is used, post-print curing subsystem 94 may comprise a UV source. According to another approach, post-print curing subsystem 94 may comprise a hot air knife, lamp, or other heat source that softens the residual ink by raising its temperature. Heating may provide the added benefit of evaporation of any remaining dampening solution. In general, however, the function of post-print curing subsystem 94 is to reduce adhesion of the ink to reimageable surface layer 20 and otherwise reduce the resistance of the residual ink to removal by the cleaning subsystem. Enhanced cleaning capacity for cleaning subsystem such as 72 or 82 may be provided. Optionally, where cleaning subsystem 82 is a multi-station cleaning system (see discussion of FIG. 9, above), it is possible to provide a post-print curing system 96 between the various stages, in addition to or an alternative to post-print curing system 94. Post-print curing systems 94, 96 may be based on the same principles, such as both being UV sources, hot air knives, etc., or may each operate on a difference principle, for example post-print curing system 94 is a UV source while post-print curing system 96 is a hot air knife, or vice-versa. This embodiment may be useful when, for example, the various stages (e.g., rollers) of a multi-stage cleaning subsystem 82 are each of a different composition or characteristic. In this way, the adhesion of any ink remaining following the first cleaning stage can be reduced and that ink more readily removed by a second cleaning stage.

An alternative cleaning system may comprise a washing station where a washing fluid is used, preferably but not necessarily in combination with shear forces such as from a brush (static, rotating or counter rotating) or impinging jet or other means, to clean ink and/or dampening solution residues from the imaging member. The cleaning fluid can be aqueous or a non-aqueous solvent, or other cleaning fluid known in the art. Hybrid cleaners comprising a spatial arrangement of one or more washing station cleaners and one or more tacky roller cleaners are also within the scope of this disclosure. Furthermore, solvents such as alcohols, toluene, isopar or other viscosity-reducing liquids may be added to the ink (or applied thereover) prior to the cleaning subsystem, by a solvent introduction subsystem (not shown), as desired to manipulate ink rheology—specifically to enhance the cleaning process.

With reference again to FIG. 1, it was stated above that in certain embodiments it may be advantageous to pre-heat the ink, such as in reservoir or on forming rollers, prior to applying that ink onto reimageable surface layer 20. Partial curing of the ink on surface layer 20 may be obtained prior to transfer subsystem 70. In certain embodiments it will be acceptable to heat the ink in a reservoir (not shown), for example by radiant heating, electrically resistive heating, chemical-reaction induced heating, etc.

However, in certain embodiments a disadvantage of heating the ink at inker subsystem reservoir is that irreversible activated changes in ink viscoelastic properties may build up over time. To overcome this, the present disclosure provides embodiments for heating the ink for a minimal amount of time immediately before transfer to surface layer 20, such that the net time the ink is at an elevated temperature is minimized. This can be achieved, for example, by utilizing a pulsed heat source immediately prior to or right at the point of transfer of the marking material from the donor roll to the reimageable surface. This pulsed heat source could be, for example, an electrical resistive heater line embedded within the surface of the ink donor roll, and/or the reimageable surface layer. By passing an electrical current of a sufficient magnitude but for a sufficiently short period of time, near-instantaneous rise in the temperature of the ink just before or right at the point of its transfer to the reimageable surface can be achieved. Alternatively, this short and rapid heating of the marking material just prior to or right at the transfer point could also be achieved through the use of a focused radiation source (e.g., a laser or focused infra-red radiator or flash lamp) or through a focused and directed jet of hot fluid such as air or other inert gas. The rapid, short pulsed heating of the marking material in this manner ensures that the heat provided to the marking material is just enough to raise its temperature to the point where the viscoelasticity is manipulated to ensure the desired splitting and transfer to the reimageable surface, without the addition of excessive heat energy that may then be conducted away to the rest of the inking system rollers, reservoir, etc., and cause undesirable changes in the ink properties, such as drying, curing, other undesirable changes in properties such as rheology or composition of the ink in the ink reservoir or fountain.

One exemplary apparatus 100 for accomplishing heating over a minimal time is illustrated in FIG. 12. Initially, ink 100 is carried from a room-temperature reservoir (not shown) by roller 102 to an intermediate (or inking) roller 104, which may be actively cooled by an appropriate mechanism such as conductive or convective cooling, using a cool-fluid source, cool-gas (e.g., air, nitrogen, argon, etc.) source, a cool roller in physical contact with roller 102, etc. (not shown), either inside of or outside of intermediate roller 104 (or both). Ink 100 is then transferred to heated nip roller 108, which is heated from the inside by a heat source 110 such as hot air (or other heated fluid) heating, radiant heating, electrically resistive heating, light-based heating, or chemical-reaction induced heating.

The material, dimensions, and other attributes of heated nip roller 108 are selected such that any heat energy imparted from heat source 110 thereto is minimized. For example, with heated nip roller 108 formed of transparent or at least translucent material, radiation can be absorbed directly by ink 100. In this case, the radiation spectrum or wavelength is selected to match the absorption spectrum of ink 100. Alternatively, radiation can be absorbed by the material comprising heated nip roller 108, and thereafter transferred to ink 100. In this case, heater nip roller 108 may comprise a thermally conductive metal such as copper, aluminum, etc. If infrared radiation (IR) is employed, the thermally conductive metal may be placed over a roller body which is transparent to IR radiation, such as plastic or glass, to provide high thermal diffusivity and low heat capacity.

In a still further approach, a heat pipe system may be incorporated within heated nip roller 108. Heated nip roller 108 may itself comprise a heating mechanism and at least one sealed, fluid-filled cavity within a cylindrical housing (e.g., double cylindrical walls with an enclosed annular cavity forming the heat pipe structure). The cavity is maintained at a controlled internal pressure corresponding to the vapor pressure of the enclosed fluid near the temperature at which effective heat transfer is desired. Through constant phase change (vaporization) at a “hot” (i.e., heat source) portion of the cavity, followed by transfer of the vaporized fluid to a “cold” (i.e., heat sink) portion of the cavity, and its subsequent condensation near the heat sink portion, large amounts of heat can be quickly transferred due to the rapid phase change heat transfer effects. Low thermal mass is required, e.g., to enable a rapid and power-efficient temperature rise in ink 100. See, e.g., U.S. Pat. No. 3,677,329, incorporated herein by reference.

With heating of ink 100 at heated nip roller 108 taking place immediately before application to surface layer 20, heating time is minimized. Furthermore, with no other ink transfer mechanism between heated nip roller 108 and surface layer 20, heating ink 100 over the desired temperature of application to compensate for losses in ancillary structures is avoided.

In one example, ink 100 is rapidly heated from room temperature to approximately 60° C. At this temperature, ink 100 exhibits reduced cohesion, and splits to adhere to areas of the surface layer 20 where dampening solution has been removed, as described earlier. Ink 100 remaining on surface layer 20 is cooled, either passively or actively, prior to its arrival at transfer subsystem 70 (FIG. 1).

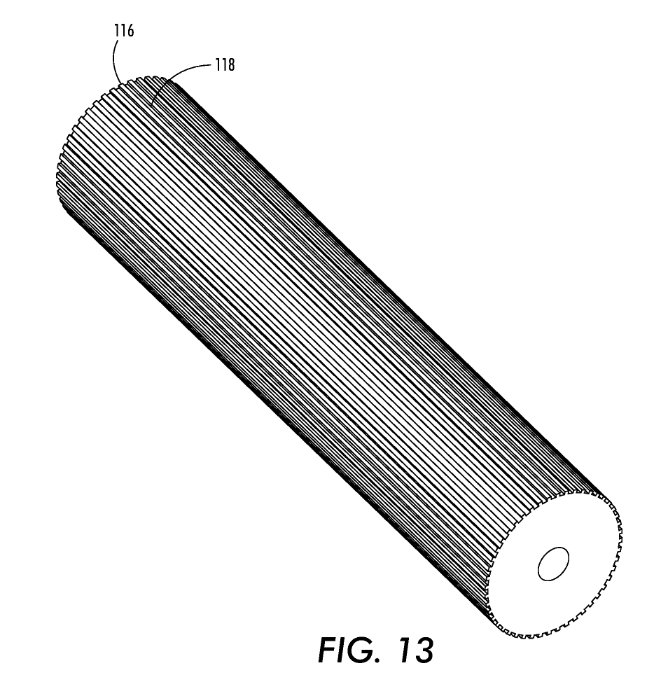

Elements of apparatus 100 may be contained in an enclosure 114 (FIG. 12), which may serve multiple purposes to control environmental parameters including trapping any small amount of volatiles in the ink. Other embodiments of a heating inking system are contemplated herein, such as the use of an anilox based keyless inking system to initially meter a given amount of ink onto the heating roller. The heating roller may be heated by some other mechanism, such as commutatively actuated electrically resistive heater strips, etc. This embodiment provides a further increase in ink transfer efficiency to the imaging member 12. In one embodiment, such as shown in FIG. 13, a heating roller 116 is divided into individually addressable regions 118 in a direction parallel to a longitudinal axis of the heating roller. Control over local temperature (e.g., specifically in the region of ink transfer) of the roller can then be provided. The temperature at each individually addressable region can be controlled, for example as a function of an image being formed by the variable data lithography system, as well as a function of the temperature at which a desired modification of the complex viscoelastic modulus of the ink is obtained.

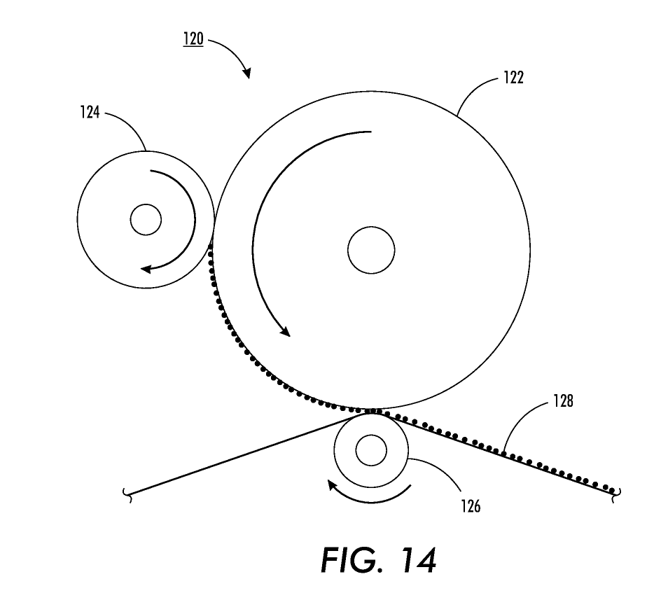

As shown in FIG. 14, the relative sizes of various of the component elements of the system may provide a further increase in ink transfer efficiency to the imaging member. In the embodiment of FIG. 14, the diameter of the inking roller 124 is relatively much larger than the diameter of the transfer nip roller 126. The relatively large diameter inking roller 124 presents a relatively slow separation from the inking 124 roller to the reimageable surface layer 122, promoting ink transfer to the reimageable surface layer 122. The relatively small diameter transfer nip roller presents a relatively fast separation from the reimageable surface layer to the substrate, promoting efficient transfer of the ink from the from the reimageable surface layer.

A system having a single imaging cylinder, without an offset or blanket cylinder, is shown and described herein. The reimageable surface layer is made from material that is conformal to the roughness of print media via a high-pressure impression cylinder, while it maintains good tensile strength necessary for high volume printing. Traditionally, this is the role of the offset or blanket cylinder in an offset printing system. However, requiring an offset roller implies a larger system with more component maintenance and repair/replacement issues, and increased production cost, added energy consumption to maintain rotational motion of the drum (or alternatively a belt, plate or the like). Therefore, while it is contemplated by the present disclosure that an offset cylinder may be employed in a complete printing system, such need not be the case. Rather, the reimageable surface layer may instead be brought directly into contact with the substrate to affect a transfer of an ink image from the reimageable surface layer to the substrate. Component cost, repair/replacement cost, and operational energy requirements are all thereby reduced.

It should be understood that when a first layer is referred to as being “on” or “over” a second layer or substrate, it can be directly on the second layer or substrate, or on an intervening layer or layers may be between the first layer and second layer or substrate. Further, when a first layer is referred to as being “on” or “over” a second layer or substrate, the first layer may cover the entire second layer or substrate or a portion of the second layer or substrate.

The invention described herein, when operated according to the method described herein meets the standard of high ink transfer efficiency, for example greater than 95% and in some cases greater than 99% efficiency of transferring ink off of the imaging cylinder and onto the substrate. In addition, the disclosure teaches combining the functions of the print cylinder with the offset cylinder wherein the rewritable imaging surface is made from material that can be made conformal to the roughness of print media via a high pressure impression cylinder while it maintains good tensile strength necessary for high volume printing. Therefore, we disclose a system and method having the added advantage of reducing the number of high inertia drum components as compared to a typical offset printing system. The disclosed system and method may work with any number of offset ink types but has particular utility with UV lithographic inks.

The physics of modern electrical devices and the methods of their production are not absolutes, but rather statistical efforts to produce a desired device and/or result. Even with the utmost of attention being paid to repeatability of processes, the cleanliness of manufacturing facilities, the purity of starting and processing materials, and so forth, variations and imperfections result. Accordingly, no limitation in the description of the present disclosure or its claims can or should be read as absolute. The limitations of the claims are intended to define the boundaries of the present disclosure, up to and including those limitations. To further highlight this, the term “substantially” may occasionally be used herein in association with a claim limitation (although consideration for variations and imperfections is not restricted to only those limitations used with that term). While as difficult to precisely define as the limitations of the present disclosure themselves, we intend that this term be interpreted as “to a large extent”, “as nearly as practicable”, “within technical limitations”, and the like.

Furthermore, while a plurality of preferred exemplary embodiments have been presented in the foregoing detailed description, it should be understood that a vast number of variations exist, and these preferred exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below.

Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

What is claimed is:

1. A method for improved application of ink in a variable data lithography system of a type including an arbitrarily reimageable imaging member having an imaging surface, a dampening solution subsystem for applying a layer of dampening solution to said imaging surface, a patterning subsystem for selectively removing portions of the dampening solution layer so as to produce a latent image in the dampening solution, an inking subsystem for applying an ink over the imaging surface such that said ink preferentially occupies regions where dampening solution was removed by the patterning subsystem to thereby form an inked latent image, an image transfer subsystem for transferring the inked latent image to a substrate, and a cleaning subsystem for removing residual ink from the surface of the imaging member, comprising:
applying said ink in a layer with a first complex viscoelastic modulus such that said ink layer readily separates in regions over the imaging surface covered by dampening solution and into regions over said imaging surface at which dampening solution has been removed by said patterning subsystem;
following application of said ink over said imaging surface and before transferring said inked latent image to said substrate, increasing the complex viscoelastic modulus of said ink to a second complex viscoelastic modulus while said ink is over said imaging surface, thereby increasing the level of at least one of ink cohesive energy and ink tack prior to the transfer of said ink to said substrate at said image transfer subsystem; and
transferring said ink to said substrate at said image transfer subsystem.

2. The method of claim 1, wherein said increase from said first to said second complex viscoelastic modulus is at least in part obtained by cooling said ink after application thereof to imaging surface.

3. The method of claim 1, wherein said increase from said first to said second complex viscoelastic modulus is at least in part obtained by partially curing said ink.

4. The method claim 3, wherein said partial curing is obtained by exposing portions of said ink to an optical beam, and further wherein said ink within said regions over said imaging surface at which dampening solution has been removed has an ink thickness, and further wherein said optical beam at least partially penetrates the ink thickness substantially without causing either total curing of the ink nor skinning-over of a surface of the ink.

5. The method of claim 4, further comprising utilizing an ink to which photoinitiators have been added, and wherein said curing is caused at least in part by exposure of the ink to said optical beam of the appropriate wavelength, such that said photoinitiators provide a reduced amount of surface skinning as well as an increased depth of cure when said ink is exposed to said optical beam for curing as compared to said ink without said photoinitiators.

6. The method of claim 1, wherein said increase in said complex viscoelastic modulus from a first lower complex viscoelastic modulus to a second higher complex viscoelastic modulus comprises reducing the temperature of said ink in situ on the surface of said imaging member.

7. The method of claim 6, wherein air from an air knife is directed to said applied ink to thereby obtain said reduction in the temperature of said ink.

8. The method claim 6, wherein ambient air temperature proximate said ink on said imaging surface results in said reduction in the temperature of said ink.

9. The method of claim 8, wherein said ambient air temperature is controlled by an ambient temperature control subsystem to a temperature below a temperature of said ink at a point of application to said imaging surface.

10. The method of claim 6, wherein said temperature of said ink in situ on the surface of said imaging member is controlled by controlling the temperature of said imaging surface.

11. The method of claim 1, wherein said increase in said complex viscoelastic modulus from a first lower complex viscoelastic modulus to a second higher complex viscoelastic modulus comprises reducing the temperature of said ink at a transfer nip proximate the point of transfer of said ink to the surface of said imaging member.

12. The method of claim 1, wherein said increase in said complex viscoelastic modulus from a first lower complex viscoelastic modulus to a second higher complex viscoelastic modulus comprises reducing the temperature of said ink at said substrate by cooling said substrate to a temperature below the temperature of said ink at the point of application thereof to said substrate.

13. The method of claim 1, wherein said ink has added thereto an additive from the group consisting of: a low molecular weight additive an organic solvent, an isopar, and a viscosity-reducing liquid; and,
cohesive energy and ink tack of said ink is increased by exposing said ink to flash heating proximate the point at which said ink is applied to said imaging surface to thereby raise the temperature of said ink at said point, inducing evaporation of said additive from said ink.

14. The method of claim 1, wherein:
said ink has added thereto an additive selected from the group consisting of: a low molecular weight additive, an organic solvent, isopar, and a viscosity reducer liquid; and,
cohesive energy and ink tack of said ink is increased by desorption of the additive from the ink preferentially into said imaging surface.

15. A method for improved application of ink in a variable data lithography system of a type including an imaging member having an imaging surface, a dampening solution subsystem for applying a layer of dampening solution to said imaging surface, an optical patterning subsystem for selectively removing portions of the dampening solution layer so as to produce a latent image in the dampening solution, an inking subsystem for applying an ink over the imaging surface such that said ink preferentially occupies regions where dampening solution was removed by the optical patterning subsystem to thereby form an inked latent image, an image transfer subsystem for transferring the inked latent image to a substrate, and a cleaning subsystem for removing residual ink and dampening solution from the surface of the imaging member, comprising:
heating said ink on a surface of a first roller by a heating subsystem associated with said first roller immediately prior to application of said ink over said imaging surface;
applying said ink in a layer having a first complex viscoelastic modulus over said imaging surface such that said ink layer readily separates from regions over the imaging surface covered by dampening solution and into regions over said imaging surface at which dampening solution has been removed by said optical patterning subsystem;
following application of said ink over said image surface and before transferring said inked latent image to said substrate, cooling said ink while said ink is over said imaging surface to thereby increase the complex viscoelastic modulus of said ink to a second complex viscoelastic modulus and thereby increase the level of at least one of ink cohesive energy and ink tack prior to the transfer of said inked latent image to said substrate at said image transfer subsystem; and
transferring said ink comprising said inked latent image to said substrate at said image transfer subsystem.
